(19) United States
(12) Patent Application Publication
(10) Pub. No.: US 2016/0332618 A1
(43) Pub. Date: Nov. 17, 2016

(54) CONTROLLER FOR VEHICLE

(71) Applicant: TOYOTA JIDOSHA KABUSHIKI KAISHA, Toyota-shi, Aichi-ken (JP)

(72) Inventors: Tomohito ONO, Susono-shi, Shizuoka-ken (JP); Takahito ENDO, Suntou-gun, Shizuoka-ken (JP); Yuji IWASE, Mishima-shi, Shizuoka-ken (JP)

(73) Assignee: TOYOTA JIDOSHA KABUSHIKI KAISHA, Toyota-shi, Aichi-ken (JP)

(21) Appl. No.: 15/110,178

(22) PCT Filed: Jan. 5, 2015
(86) PCT No.: PCT/IB2015/000004

§ 371 Date: Jul. 7, 2016

(30) Foreign Application Priority Data
Jan. 9, 2014 (JP) 2014-002596

(51) Int. Cl. B60W 20/20; B60W 20/40; B60K 6/442; B60K 6/383; B60K 6/387

(52) U.S. Cl. CPC B60W 20/20; B60K 6/383; B60K 6/387; B60K 6/442; B60W 20/40; Y10S 903/913; Y10S 903/914; B60Y 2200/92; B60Y 2300/182; B60Y 2300/188; B60Y 2400/427; B60Y 2400/302; B60W 2510/107; B60W 2710/021

(57) ABSTRACT

A vehicle includes an engine, a rotary machine, at least one driving wheel, a first clutch disposed between a power transmission path and the rotary machine, the power transmission path being defined between the engine and the driving wheel, the first clutch being switched to an engaged state or a disengaged state, a one-way clutch disposed in parallel with the first clutch, an oil temperature detector configured to detect a temperature of oil supplied to a power transmission part including the rotary machine, and an electronic control unit. The electronic control unit is configured to limit an operating zone in which a predetermined traveling mode is allowed when the oil temperature detected by the oil temperature detector is low compared to when the oil temperature is high, where the predetermined traveling mode is a traveling mode in which the vehicle travels with the rotation of the rotary machine being stopped.

### BACKGROUND OF THE INVENTION

1. Field of the Invention

The present invention relates to a controller for a vehicle.

2. Description of Related Art

In the related art, a vehicle including a one-way clutch is known. For example, Japanese Patent Application Publication No. 2013-96555 (JP 2013-96555 A) discloses a technique of a connection mechanism for a vehicle driving system which is provided with a mechanical connection and disconnection unit in which a sleeve or a pole can engage with dog-teeth so as to be parallel to the one-way clutch. JP 2013-96555 A also discloses a configuration in which the one-way clutch and the mechanical connection and disconnection unit are disposed between a second M/G 58 and a transmission gear 12a. In the technique disclosed in JP 2013-96555 A, the mechanical connection and disconnection unit is engaged when the vehicle travels in reverse.

### SUMMARY OF THE INVENTION

In the configuration described in JP 2013-96555 A, when the mechanical connection and disconnection unit is disengaged, the second M/G 58 may be stopped. Control of the operation of a rotary machine such as the second M/G 58 has not been satisfactorily studied.

For example, when a clutch capable of being arbitrarily engaged or disengaged and a one-way clutch are arranged in parallel between a power transmission path and a rotary machine, the rotary machine can be stopped in a state where the clutch is disengaged. By stopping the rotary machine, it is possible to achieve a decrease in loss such as frictional loss. However, in a situation in which the oil temperature is low such as just after a cold start, the loss may increase rather by stopping the rotary machine. When the rotary machine is stopped, there is no rise in oil temperature due to heat generated from the rotary machine and thus the rise in oil temperature is delayed. As a result, the loss due to the low oil temperature may be greater than the loss due to the operation of the rotary machine. Accordingly, there is demand for decreasing the loss in the vehicle.

An object of the invention provides a controller for a vehicle that can decrease loss in the vehicle due to a low oil temperature.

According to an aspect of the invention, there is provided a controller for a vehicle. The vehicle includes an engine, a rotary machine, driving wheels, a first clutch disposed between a power transmission path and the rotary machine, the power transmission path being defined between the engine and the driving wheel, the first clutch being switched to an engaged state or a disengaged state, a second clutch disposed in parallel with the first clutch, the second clutch being a one-way clutch, and an oil temperature detector configured to detect a temperature of oil supplied to a power transmission part including the rotary machine. The controller includes an electronic control unit. The electronic control unit is configured to further limit an operating zone in which a predetermined traveling mode is allowed when the oil temperature detected by the oil temperature detector is low rather than when the oil temperature is high. The predetermined traveling mode is a traveling mode in which the vehicle travels with the rotation of the rotary machine being stopped.

In the aspect, the electronic control unit may be configured to inhibit the predetermined traveling mode when the oil temperature is equal to or lower than a predetermined temperature.

In the aspect, the electronic control unit may be configured to cause the vehicle to run using the rotary machine as a power source when the oil temperature is equal to or lower than the predetermined temperature.

In the aspect, the electronic control unit may be configured to enlarge the operating zone in which the predetermined traveling mode is allowed as the oil temperature becomes higher in a temperature range in, which the oil temperature is higher than the predetermined temperature.

According to an aspect of the invention, there is provided a controller for a vehicle. The vehicle includes an engine, a rotary machine, driving wheels, a first clutch disposed between a power transmission path between the engine and the driving wheels and the rotary machine, the first clutch being switched to an engaged state or a disengaged state, a second clutch disposed in parallel with the first clutch, the second clutch being a one-way clutch, an oil temperature detector configured to detect a temperature of oil supplied to a power, transmission part including the rotary machine, and the controller. The controller includes an electronic control unit. The electronic control unit is configured to further limit an operating zone in which a predetermined traveling mode is allowed when the oil temperature detected by the oil temperature detector is low rather than when the oil temperature is high. The predetermined traveling mode is a traveling mode in which the vehicle travels with the rotation of the rotary machine being stopped. According to this aspect, it is possible to achieve an effect of decreasing loss in the vehicle due to a low oil temperature.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart illustrating an operation flow of a controller for a vehicle according to an embodiment of the invention;

FIG. 2 is a diagram schematically illustrating a configuration of a vehicle according to the embodiment;

FIG. 3 is a skeleton diagram of the vehicle according to the embodiment;

FIG. 4 is a block diagram illustrating the controller for a vehicle according to the embodiment;

FIG. 5 is a collinear diagram illustrating an example of a traveling state according to the embodiment;

FIG. 6 is a collinear diagram illustrating another example of the traveling state according to the embodiment;

FIG. 7 is a collinear diagram illustrating still another example of the traveling state according to the embodiment;

FIG. 8 is a diagram illustrating an operation engagement table according to the embodiment;

FIG. 9 is a diagram illustrating a relationship between an oil temperature and an allowable range;

FIG. 10 is a diagram illustrating a relationship between a vehicle speed and an allowable range;

FIG. 11 is a diagram illustrating a map of an allowable range according to a first modification example of the embodiment;

FIG. 12 is a diagram illustrating a map of an allowable range according to a second modification example of the embodiment; and

FIG. 13 is a diagram illustrating, a map of an allowable range according to a third modification example of the embodiment.

### DETAILED DESCRIPTION OF EMBODIMENTS

Hereinafter, a vehicle controller according to an embodiment of the invention will be described in detail with reference to the accompanying drawings. The invention is not limited to the embodiment. Elements in the below embodiment include elements that can be easily conceived of by those skilled in the art or elements that are substantially identical thereto.

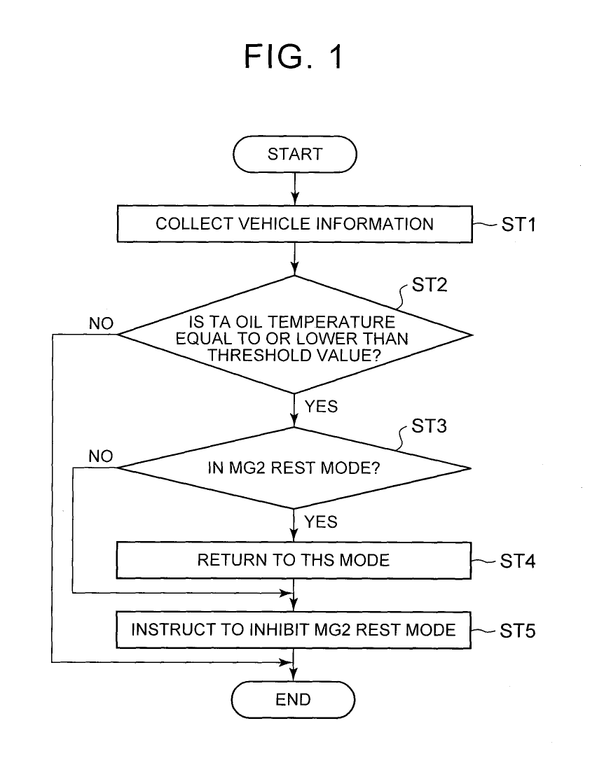

The embodiment of the invention will be described below with reference to FIGS. 1 to 10. This embodiment provides a vehicle controller.

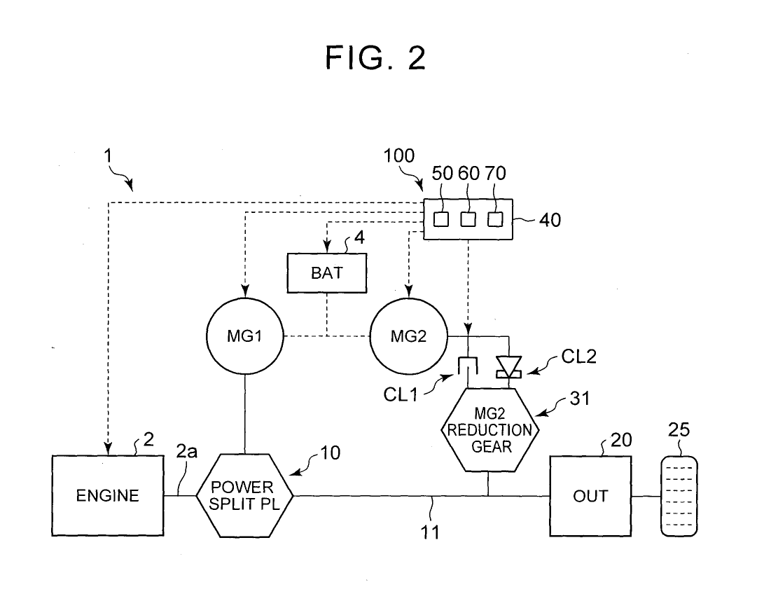

As illustrated in FIG. 2, a vehicle 1 according to this embodiment includes an engine 2, a first rotary machine MG1, a second rotary machine MG2, a battery 4, a planetary gear mechanism 10, a first clutch CL1, a second clutch CL2, a control unit 40, and an output shaft 20. The vehicle 1 is a hybrid vehicle including the engine 2 and two rotary machines MG1, MG2 as drive sources. The vehicle 1 may be a plug-in hybrid vehicle (PHV) that can be charged with an external power source.

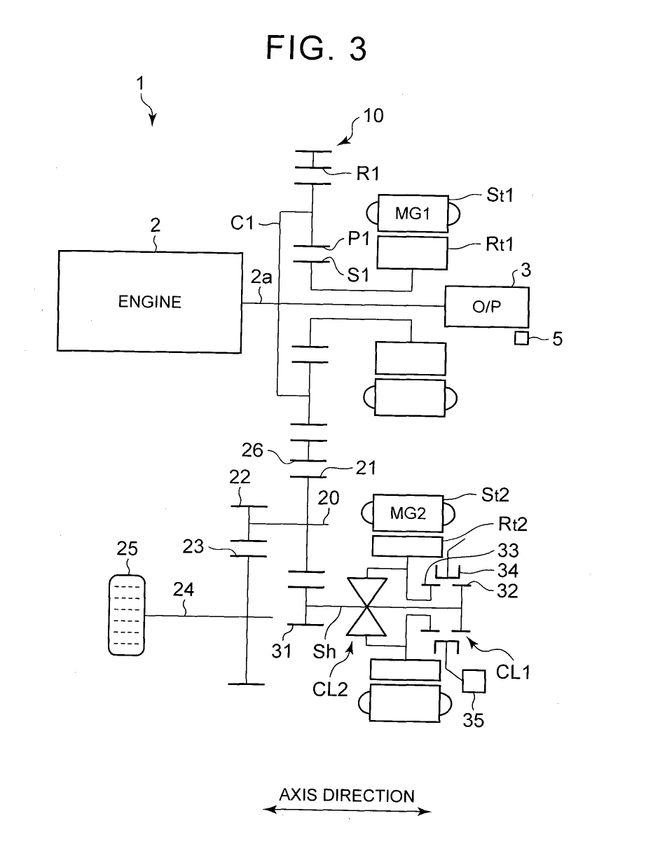

A vehicle control system 100 according to this embodiment includes the engine 2, the second rotary machine MG2, the first clutch CL1, the second clutch CL2, an oil temperature sensor 5 (see FIG. 3), and the control unit 40 in the vehicle 1.

The engine 2 converts the combustion energy of fuel into the rotation of an output shaft 2a and outputs the rotation. The planetary gear mechanism 10 has a function as a power split planetary gear splitting the power output from the engine 2 into the output shaft 20 and the first rotary machine MG1. The first rotary machine MG1 and the second rotary machine MG2 have a function as a motor (electric motor) and a function as a power generator. The first rotary machine MG1 and the second rotary machine MG2 are connected to the battery 4 via an inverter. The power generated by the rotary machines MG1, MG2 can be stored in the battery 4. For example, a three-phase AC synchronization type motor-generator set can be used as the first rotary machine MG1 and the second rotary machine MG2.

The first clutch CL1 is disposed between the transmission path 11 and the second rotary machine MG2. The first clutch CL1 is a clutch unit that can be arbitrarily switched between an engaged state and a disengaged state. Here, the transmission path 11 is a transmission path of power between the engine 2 and the driving wheels 25. The transmission path 11 in this embodiment is a transmission path that transmits power between the planetary gear mechanism 10 and the driving wheels 25. The second clutch CL2 is a one-way clutch disposed in parallel with the first clutch CL1. For example, a sprag type one-way clutch can be used as the second clutch CL2.

The second rotary machine MG2 transmits and receives power to and from the transmission path 11 via at least one of the first clutch CL1 or the second clutch CL2. The power output from the engine 2 and the second rotary machine MG2 to the transmission path 11 is transmitted to the driving wheels 25 via the output shaft 20.

The vehicle control system 100 according to this embodiment has a predetermined traveling mode in which the vehicle 1 travels forward with the rotation of the second rotary machine MG2 stopped. In the predetermined traveling mode, the first clutch CL1 is in the disengaged state. Since the first clutch CL1 is disengaged and the second rotary machine MG2 is separated from the transmission path 11, the rotation of the second rotary machine MG2 along with the rotation of the transmission path 11 is suppressed and thus a dragging loss or a mechanical loss in the secondary rotary machine MG2 is reduced. Since the loss occurring in the second rotary machine MG2 is reduced, the output power of the engine 2 can be reduced by the loss. Accordingly, the vehicle control system 100 according to this embodiment can achieve a decrease in loss or an improvement in fuel efficiency of the vehicle 1.

An example of the specific configuration of the vehicle 1 will be described below with reference to FIG. 3. As illustrated in FIG. 3, the output shaft 2a of the engine 2 is connected to a carrier C1 of the planetary gear mechanism 10. The planetary gear mechanism 10 is a single-pinion planetary gear mechanism. The planetary gear mechanism 10 includes a sun gear S1, a pinion gear P1, a ring gear R1, and a carrier C1. The planetary gear mechanism 10 is disposed between the engine 2 and the first rotary machine MG1 in the axis direction of the output shaft 2a. The planetary gear mechanism 10 and the first rotary machine MG1 are arranged coaxial with the engine 2. The axis direction of the engine 2 is parallel to, for example, a vehicle width direction.

The first rotary machine MG1 includes a rotor Rt1 that is rotatably supported and a stator St1 that is fixed to a vehicle body side. The sun gear S1 is connected to the rotor Rd of the first rotary machine MG1 and rotates along with the rotor Rt1. An output gear 26 disposed on the outer circumference of the ring gear R1 meshes with a driven gear 21. The driven gear 21 is a gear connected to the output shaft 20. The output shaft 20 is a shaft parallel to the output shaft 2a of the engine 2 and a rotation shaft Sh to be described later. A drive pinion gear 22 is connected to the output shaft 20. The drive pinion gear 22 meshes with a final gear 23. The final gear 23 is connected to the driving wheels 25 via a drive shaft 24. A differential gear may be disposed between the final gear 23 and the drive shaft 24.

A reduction gear 31 meshes with the driven gear 21. The reduction gear 31 is connected to the rotation shaft Sh. The second rotary machine MG2 is disposed coaxial with the rotation shaft Sh. The second rotary machine MG2 includes a rotor Rt2 that is rotatably supported and a stator St2 that is fixed to the vehicle body side. The first clutch CL1 and the second clutch CL2 are disposed between the rotation shaft Sh and the rotor Rt2 of the second rotary machine MG2.

The first clutch CL1 in this embodiment is a meshing type dog clutch. The first clutch CL1 includes first dog-teeth 32, second dog-teeth 33, a sleeve 34, and an actuator 35. The first dog-teeth 32 are dog-teeth connected to the rotation shaft Sh. The second dog-teeth 33 are dog-teeth connected to the rotor Rt2 of the second rotary machine MG2. The first dog-teeth 32 and the second dog-teeth 33 are, for example, teeth extending linearly in the axis direction of the engine 2. The sleeve 34 is supported to be movable in the axis direction. The sleeve 34 has dog-teeth corresponding to the first dog-teeth 32 and the second dog-teeth 33.

The actuator 35 is configured to engage or disengage the first clutch CL1 by moving the sleeve 34 in the axis direction of the engine 2. The first clutch CL1 in this embodiment is a normally-open type clutch and is switched to the disengaged state when the actuator 35 does not generate a drive force. The actuator 35 drives the sleeve 34 in one direction (engagement direction) of the axis direction of the engine 2, for example, with an electromagnetic force. On the other hand, the sleeve 34 is impelled in the direction (disengagement direction) opposite to the direction of the drive force based on the actuator 35 with an impelling member such as a spring. Accordingly, the sleeve 34 is maintained in the disengaged state with the impelling force of the impelling member when the actuator 35 does not generate a drive force. The actuator 35 moves the sleeve 34 in the engagement direction with the generated drive force against the impelling force so as to cause the sleeve 34 to engage with both the first dog-teeth 32 and the second dog-teeth 33. Accordingly, the first clutch CL1 is engaged and thus the rotation shaft Sh and the rotor Rt2 are connected via the sleeve 34 so as to rotate together.

In this embodiment, among both of the rotation directions of the second rotary machine MG2, the same direction as the rotation direction of the rotation shaft Sh when the vehicle 1 travels forward is referred to as a “positive rotation direction”. In this embodiment, among both of the rotation directions of the second rotary machine MG2, the reverse rotation direction of the positive rotation direction is referred to as a “negative rotation direction” or a “reverse rotation direction”. Among the torques of the second rotary machine MG2, the torque in the same direction as the rotation direction of the second rotary machine MG2 is referred to as a “positive torque”. Among the torques of the second rotary machine MG2, the torque in the reverse direction of the positive rotation direction of the second rotary machine MG2 is referred to as a “negative torque” or a “reverse torque”. That is, the positive torque is a torque in the direction in which the positive rotation speed of the second rotation machine MG2 increases. On the other hand, the negative torque is a torque in the direction in which the positive rotation speed of the second rotary machine MG2 decreases. In other words, the negative torque is a torque in the direction in which the positive rotation of the second rotary machine MG2 decreases and the negative rotation thereof is accelerated.

The second clutch CL2 can transmit the torque in the positive rotation direction from the second rotary machine MG2 to the rotation shaft Sh and intercepts the torque in the negative rotation direction. On the other hand, the second clutch CL2 can transmit the torque in the negative rotation direction from the rotation shaft Sh to the second rotary machine MG2 and intercepts the torque in the positive rotation direction.

An oil pump 3 is connected to the output shaft 2a of the engine 2. The oil pump 3 ejects oil with the rotation of the engine 2. The oil pump 3 supplies oil to a power transmission member including the first rotary machine MG1 and the second rotary machine MG2. The oil supplied by the oil pump 3 lubricates and cools the first rotary machine MG1 and the second rotary machine MG2. The oil pump 3 may supply oil to a lubricated part including the planetary gear mechanism 10.

The vehicle 1 includes an oil temperature sensor (oil temperature detector) 5 detecting the temperature of oil supplied to the power transmission part including the second rotary machine MG2. The oil temperature sensor 5 in this embodiment detects the temperature of oil supplied to the oil pump 3. The position at which the oil temperature is detected is not limited to the oil pump 3. The oil temperature sensor 5 may detect the oil temperature of an oil pan.

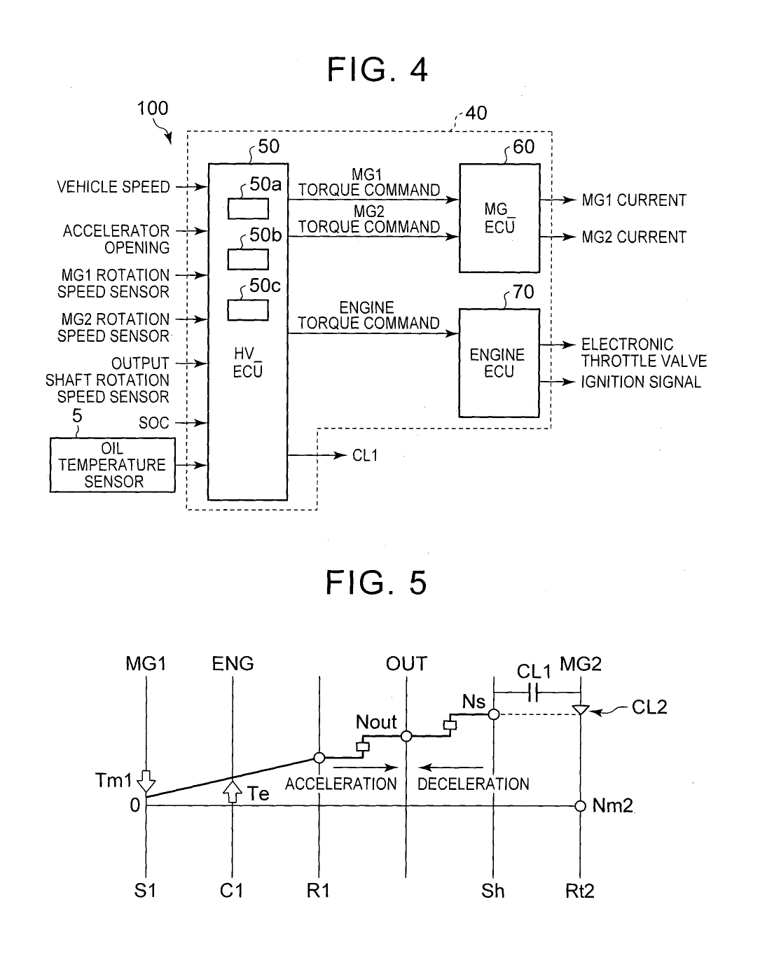

As illustrated in FIG. 4, the control unit 40 includes an HV_ECU 50, an MG_ECU 60, and an engine ECU 70. The control unit 40 has a function of controlling the traveling of the vehicle 1. The ECUs 50, 60, and 70 are, for example, electronic control units having a computer. The HV_ECU 50 has a function of comprehensively controlling the entire vehicle 1. The MG_ECU 60 and the engine ECU 70 are electrically connected to the HV_ECU 50.

The MG_ECU 60 can control the first rotary machine MG1 and the second rotary machine MG2. For example, the MG_ECU 60 adjusts a current value supplied to the first rotary machine MG1 so as to control the output torque of the first rotary machine MG1. For example, the MG_ECU 60 adjusts a current value supplied to the second rotary machine MG2 so as to control the output torque of the second rotary machine MG2.

For example, the engine ECU 70 can perform controlling an electronic throttle valve of the engine 2, outputting an ignition signal to control the ignition of the engine 2, and controlling injection of fuel into the engine 2.

A vehicle speed sensor, an accelerator opening sensor, an MG1 rotation speed sensor, an MG2 rotation speed sensor, an output shaft rotation speed sensor, a battery sensor, and the like are connected to the HV_ECU 50. The HV_ECU 50 can acquire a vehicle speed, an accelerator opening, a rotation speed of the first rotary machine MG1, a rotation speed of the second rotary machine MG2, a rotation speed of the output shaft 20, a battery state SOC, and the like from the sensors. The HV_ECU 50 is connected to the oil temperature sensor 5 and acquires information indicating the detection result of the oil temperature sensor 5.

The HV_ECU 50 includes a drive force calculating unit 50a, a mode determining unit 50b, and a condition setting unit 50c. The drive force calculating unit 50a calculates a request drive force for the vehicle 1 on the basis of information acquired by the HV_ECU 50. The drive force calculating unit 50a may calculate request power, a request torque, and the like instead of the request drive force. The HV_ECU 50 determines the output torque of the first rotary machine MG1 (hereinafter, also referred to as “MG1 torque”), the output torque of the second rotary machine MG2 (hereinafter, also referred to as “MG2 torque”), and the output torque of the engine 2 (hereinafter, also referred to as “engine torque”) on the basis of the request value calculated by the drive force calculating unit 50a. The HV_ECU 50 outputs a command value of the MG1 torque and a command value of the MG2 torque to the MG_ECU 60. The HV_ECU 50 outputs a command value of the engine torque to the engine ECU 70.

The traveling state of the vehicle 1 will be described below with reference to the accompanying drawings. In the collinear diagrams illustrated in FIGS. 5 to 7, the S1 axis represents the rotation speed of the sun gear S1 and the first rotary machine MG1. In the collinear diagrams, the C1 axis represents the rotation speeds of the carrier C1 and the engine 2. In the collinear diagrams, the R1 axis represents the rotation speed of the ring gear R1. The OUT axis represents the rotation speed of the output shaft 20. The Sh axis represents the rotation speed of the rotation axis Sh. The Rt2 axis represents the rotation speed of the rotor Rt2 of the second rotary machine MG2. In the below description, the rotation speed of the rotation shaft Sh is referred to as “shaft rotation speed Ns”. In the below description, the rotation speed of the rotor Rt2 is referred to as “MG2 rotation speed Nm2”. The rotation speed of the output shaft 20 is referred to as “output shaft rotation speed Nout”.

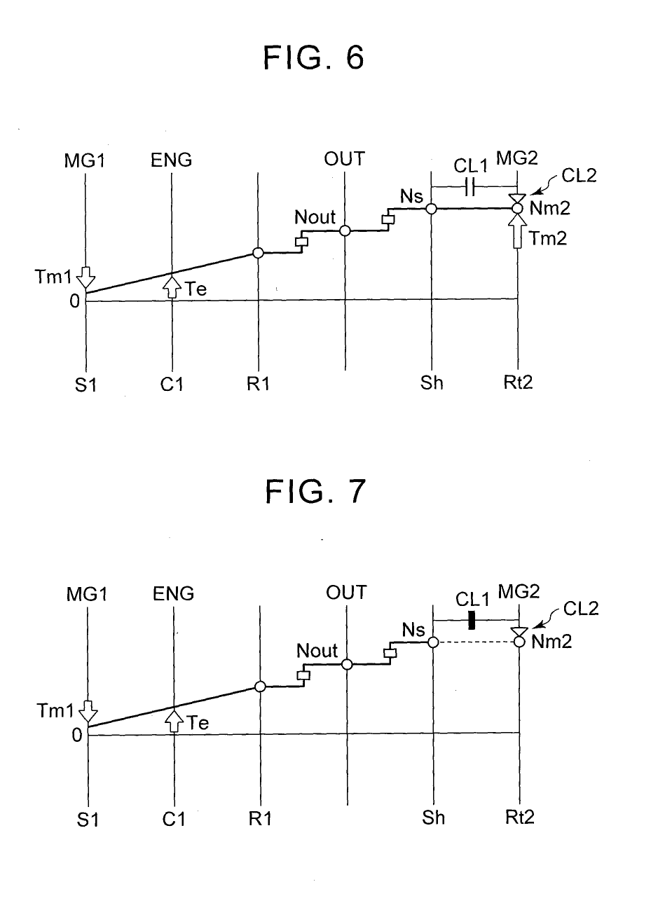

FIGS. 5 and 6 illustrate a state where the first clutch CL1 is disengaged. FIG. 7 illustrates a state where the first clutch CL1 is engaged.

In the vehicle 1 according to this embodiment, as illustrated in FIG. 3, the outer diameter of the ring gear R1 is greater than the outer diameter of the driven gear 21. Accordingly, the rotation of the ring gear R1 is increased in speed and is then transmitted to the output shaft 20. The outer diameter of the reduction gear 31 is smaller than the outer diameter of the driven gear 21. Accordingly, the shaft rotation speed Ns of the rotation shaft Sh is decreased and is then transmitted to the output shaft 20. That is, the reduction gear 31 is a gear that can decrease and transmit the MG2 rotation speed Nm2 to the output shaft 20.

The second clutch CL2 is switched to the disengaged state as illustrated in FIG. 5 when the MG2 rotation speed Nm2 is lower than the shaft rotation speed Ns (including a case in which the second rotary machine MG2 rotates negatively) while the vehicle 1 travels forward. On the other hand, the second clutch CL2 is switched to the engaged state as illustrated in FIG. 6 and transmits power from the second rotary machine MG2 to the rotation shaft Sh when the MG2 rotation speed Nm2 is synchronized with the shaft rotation speed Ns. That is, when the vehicle 1 travels forward and the MG2 rotation speed Nm2 is increased by setting the MG2 torque Tm2 to the positive torque, the second clutch CL2 is engaged. Accordingly, the MG2 torque Tm2 is transmitted to the rotation shaft Sh via the second clutch CL2.

When the MG2 rotation speed Nm2 is lower than the shaft rotation speed Ns while the vehicle travels forward, the second clutch CL2 is switched to the disengaged state. That is, when the rotation speed of the second rotary machine MG2 is decreased from the state in which the vehicle travels forward using the second rotary machine MG2 as a drive source by powering the second rotary machine MG2, the second clutch CL2 is switched from the engaged state to the disengaged state. Accordingly, when the first clutch CL1 is in the disengaged state, the second clutch CL2 can be switched to the disengaged state by decreasing the rotation speed of the second rotary machine MG2. When the second clutch CL2 is in the disengaged state, the second rotary machine MG2 is separated from the transmission path 11. Accordingly, the vehicle 1 can also run with the rotation of the second rotary machine MG2 stopped.

As illustrated in FIG. 7, when the first clutch CL1 is in the engaged state, a torque in any rotation direction (the positive rotation direction and the negative rotation direction) can be transmitted between the second rotary machine MG2 and the rotation shaft Sh. Accordingly, when the vehicle travels forward with the first clutch CL1 in the engaged state, the vehicle 1 can be accelerated with the positive torque output from the second rotary machine MG2. The vehicle 1 can also be braked or regenerate energy by causing the second rotary machine MG2 to generate a negative torque when the vehicle travels forward with the first clutch CL1 in the engaged state.

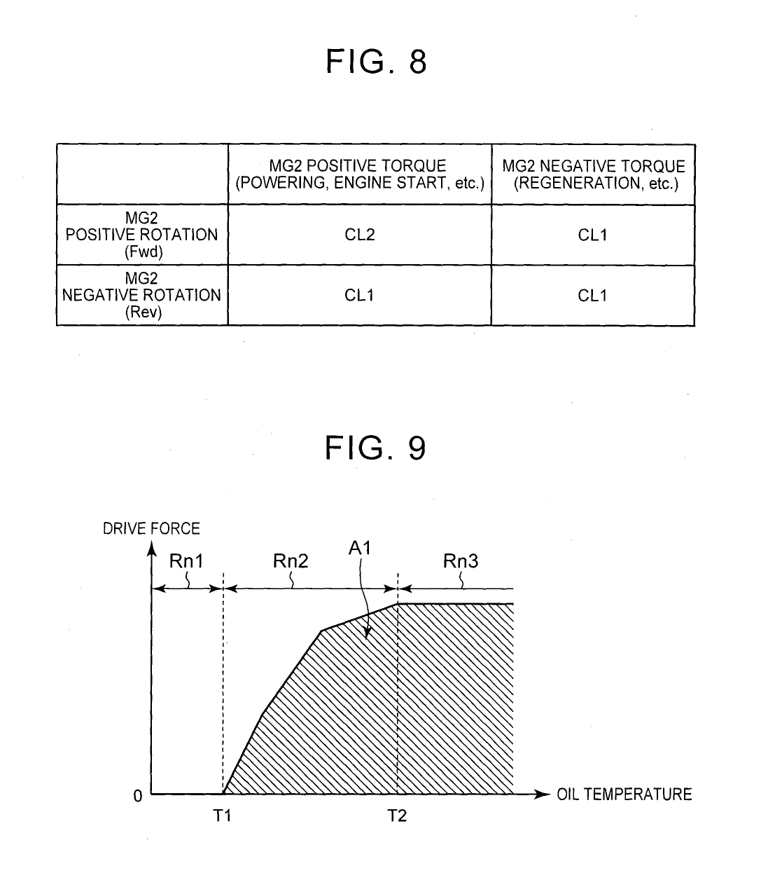

The control unit 40 controls engagement or disengagement of the first clutch CL1, for example, as illustrated in FIG. 8. FIG. 8 illustrates combinations of the positive and negative signs of the rotation direction of the second rotary machine MG2, the positive and negative signs of the torque, and the clutches in the engaged state. When the second rotary machine MG2 rotates positively and the MG2 torque is a positive torque, that is, when the vehicle travels forward using the second rotary machine MG2 as a drive source or when the engine 2 is started with the MG2 torque, the first clutch CL1 is in the disengaged state. Accordingly, the second clutch CL2 is engaged when power is transmitted from the second rotary machine MG2 to the transmission path 11.

When the second rotary machine MG2 rotates positively and the MG2 torque is a negative torque, that is, when the torque in the braking direction is output from the second rotary machine MG2 while the vehicle travels forward, the first clutch CL1 is engaged. Accordingly, the braking torque output from the second rotary machine MG2 is transmitted to the transmission path 11 via the first clutch CL1 and the regeneration of the second rotary machine MG2 and the like is performed.

When the second rotary machine MG2 rotates negatively and the MG2 torque is a positive torque, that is, when the vehicle travels in reverse with the second rotary machine MG2 as a drive source, the first clutch CL1 is engaged. Accordingly, the torque in the negative rotation direction from the second rotary machine MG2 is transmitted to the transmission path 11 via the first clutch CL1 and the vehicle 1 can be driven to run reverse with the MG2 torque.

When the second rotary machine MG2 rotates negatively and the MG2 torque is a negative torque, for example, when the torque in the braking direction is output from the second rotary machine MG2 while the vehicle travels in reverse, the first clutch CL1 is engaged. In this combination of the rotation direction and the torque direction, the second clutch CL2 is engaged in principle. Accordingly, it may be considered that the first clutch CL1 is in the disengaged state. However, the case of this combination of the rotation direction and the torque is typically a case in which the braking operation is performed at the time of traveling in reverse, and the frequency in which the braking operation is performed at the time of traveling in reverse is less in whole travel period. At the time of traveling in reverse, the ON and OFF states of the brake may be frequently switched to each other. When the engagement and the disengagement of the first clutch CL1 are repeated whenever the ON and OFF states of the brake are switched, the control becomes complicated, which is not desirable. Accordingly, in this embodiment, when the second rotary machine MG2 rotates negatively as described above, the first clutch CL1 is maintained in the engaged state.

The mode determining unit 50b of the HV_ECU 50 selects an HV traveling mode or an EV traveling mode on the basis of the calculated request drive force, the calculated vehicle speed, or the like. The HV traveling mode is a traveling mode in which the vehicle 1 travels with at least the engine 2 as a drive source. In the HV traveling mode, the first rotary machine MG1 can serve as a part receiving a reaction force against the engine torque. The first rotary machine MG1 generates a reaction torque Tm1 against the engine torque Te and outputs power of the engine 2 from the ring gear R1, for example, as illustrated in FIG. 5. The power of the engine 2 output from the ring gear R1 is transmitted from the output shaft 20 to the driving wheels 25.

In the HV traveling mode, the first clutch CL1 is, for example, in the disengaged state. Since the first clutch CL1 is of a normally-opened type, the first clutch CL1 does not consume electric power in the disengaged state. Accordingly, by performing the HV traveling mode with the first clutch CL1 set to the disengaged state, it is possible to reduce power consumption.

In the HV traveling mode, the vehicle 1 may run with the second rotary machine MG2 in addition to the engine 2 as a drive source. When the second rotary machine MG2 is used as the drive source at the time of traveling forward, the HV_ECU 50 causes the second rotary machine MG2 to rotate positively and to output a positive torque. When the MG2 rotation speed Nm2 increases and is synchronized with the shaft rotation speed Ns, the second clutch CL2 is engaged. Accordingly, the power of the second rotary machine MG2 is transmitted to the output shaft 20 via the second clutch CL2 and the rotation shaft Sh.

The HV_ECU 50 can cause the second rotary machine MG2 to perform regeneration in the HV traveling mode. When the second rotary machine MG2 performs regeneration, the HV_ECU 50 switches the first clutch CL1 to the engaged state. When the second clutch CL2 is already engaged, the engaging operation of the first clutch CL1 can be started without any change in that the MG2 rotation speed Nm2 is synchronized with the shaft rotation speed Ns. When the first clutch CL1 is engaged, the HV_ECU 50 causes the second rotary machine MG2 to generate a negative torque (torque in the reverse direction of the rotation direction) and causes the second rotary machine MG2 to generate power.

The EV traveling mode is a traveling mode in which the vehicle 1 travels with the second rotary machine MG2 as a drive source. When the vehicle 1 travels forward in the EV traveling mode, the first clutch CL1 is, for example, in the disengaged state. The HV_ECU 50 causes the second rotary machine MG2 to output the torque in the positive rotation direction and causes the secondary rotary machine MG2 to rotate positively. Accordingly, the second clutch CL2 is engaged and the positive torque output from the second rotary machine MG2 drives the vehicle 1 to move forward. The HV_ECU 50 sets the first rotary machine MG1 to a free state in which the first rotary machine MG1 performs neither powering nor regeneration in the EV traveling mode. Accordingly, in the EV traveling mode, the engine 2 stops the rotation thereof and the first rotary machine MG1 idles.

The HV_ECU 50 can cause the second rotary machine MG2 to perform regeneration in the EV traveling mode. When the second rotary machine MG2 performs regeneration, the HV_ECU 50 switches the first clutch CL1 to the engaged state. When the first clutch CL1 is engaged, the HV_ECU 50 causes the second rotary machine MG2 to generate a negative torque (torque in the reverse direction of the rotation direction) and causes the second rotary machine MG2 to generate power.

The vehicle control system 100 according to this embodiment has a predetermined traveling mode. The predetermined traveling mode is a traveling mode in which the vehicle 1 travels using the engine 2 as a power source with the first clutch CL1 disengaged and with the second rotary machine MG2 separated from the transmission path 11. The predetermined traveling mode may be considered to be a type of the HV traveling mode. In this embodiment, the second clutch CL2 is also in the disengaged state in the predetermined traveling mode. In the predetermined traveling mode, the torque generated from the second rotary machine MG2 is neither used as a torque for driving the vehicle 1 nor as a torque for braking the vehicle 1. That is, the second rotary machine MG2 in the predetermined traveling mode is in a rest state in which the second rotary machine is neither operated as a drive force source nor the braking force source of the vehicle 1. Accordingly, the predetermined traveling mode may be referred to as a rest mode in which the second rotary machine MG2 is stopped. The second rotary machine MG2 in the predetermined traveling mode is in a standby state for waiting for transition to the HV traveling mode or the like using the second rotary machine MG2 as a power source. Therefore, the predetermined traveling mode may be referred to as a standby mode for causing the second rotary machine MG2 to wait.

In this embodiment, in the predetermined traveling mode, the vehicle 1 travels with the rotation of the second rotary machine MG2 stopped. Since the second rotary machine MG2 is stopped in the predetermined traveling mode, a dragging loss, a mechanical loss, an electrical loss, and the like of the second rotary machine MG2 are reduced. Here, the state in which the second rotary machine MG2 is stopped in the predetermined traveling mode includes a state in which the MG2 rotation speed Nm2 is zero, a state in which the second rotary machine MG2 rotates at the MG2 rotation speed Nm2 which is a low rotation speed (for example, several tens of rpm) equal to or less than a detection limit of the MG2 rotation speed sensor, and the like.

In the predetermined traveling mode, an electrical loss may be decreased as will be described below. For example, a vehicle having a configuration in which the rotor Rt2 of the second rotary machine MG2 is directly connected to the rotation shaft Sh without passing through the clutches CL1, CL2 is known. In such a vehicle, even when there is no merit that the second rotary machine MG2 is in a rotating state, the second rotary machine MG2 rotates together. In a traveling state in which it is not necessary to use the second rotary machine MG2 as the drive source of the vehicle 1 and the second rotary machine MG2 does not need to perform the regeneration or the braking, when the second rotary machine MG2 is connected to the transmission path 11, the second rotary machine MG2 rotates together. In this case, when the second rotary machine MG2 rotates, the second rotary machine MG2 may unintentionally generate electric power. When suppression of the charging of the battery 4 with the unintentional power generation is intended, the charging of the battery 4 can be suppressed by boosting a voltage through the use of an inverter to match the electromotive force of the second rotary machine MG2. However, this method has a-problem in that an electrical loss due to the boosting may be caused.

On the contrary, the vehicle control system 100 according to this embodiment has a predetermined traveling mode. In the predetermined traveling mode, the second rotary machine MG2 is separated from the transmission path 11. Accordingly, the unintentional power generation by the second rotary machine MG2 is prevented and the generation of an electrical loss is suppressed.

In this embodiment, the mode determining unit 50b of the control unit 40 determines whether to perform the predetermined traveling mode on the basis of the operating zone. The mode determining unit 50b determines whether to perform the predetermined traveling mode, for example, on the basis of the vehicle speed and the drive force. The predetermined traveling mode is performed, for example, in a low-load operating zone. The low-load operating zone is an operating zone in which a request drive force for the vehicle 1 can be output, for example, on the basis of the output torque of the engine 2. In the low-load operating zone, it is thought that it is advantageous to separate the second rotary machine MG2 from the transmission path 11.

For example, in a zone with a high vehicle speed and a low load, the predetermined traveling mode may be performed. In a high vehicle speed zone, the rotation speed of the engine 2 is relatively high and the engine 2 can be operated at an operating point at which the efficiency is good. In the high vehicle speed zone, the dragging loss or the mechanical loss occurring in the second rotary machine MG2 is likely to be large. In other words, it is thought that there is a great merit obtained by separating the second rotary machine MG2 from the transmission path 11 in the predetermined traveling mode.

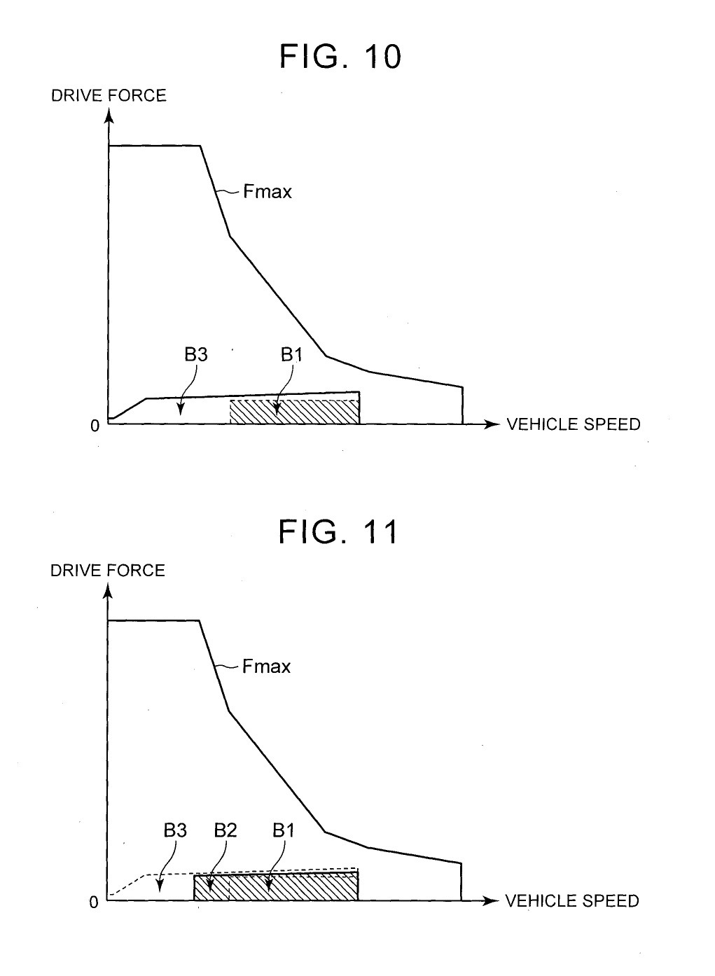

The control unit 40 allows the predetermined traveling mode, for example, in an allowable zone B3 illustrated in FIG. 10. In FIG. 10, the horizontal axis represents the vehicle speed and the vertical axis represents the drive force required for the vehicle 1 or the target drive force of the vehicle 1. The allowable zone B3 represents the relationship between the vehicle speed and the range of the drive force in which the predetermined traveling mode can be performed. A maximum drive force line Fmax is a line indicating the maximum drive force that can be output in a THS mode (HV traveling mode) in which the vehicle travels using the engine 2 and the second rotary machine MG2 as the drive source. The allowable zone B3 is determined as a zone of positive drive force (forward drive force). At each vehicle speed, the allowable zone B3 is a zone on a low load side in a drive force zone equal to or less than the maximum drive force line Fmax. In a zone on a higher load side than the allowable zone B3, the predetermined traveling mode is inhibited. In addition, a zone of negative drive force, that is, in a zone on a deceleration side, the predetermined traveling mode is inhibited.

Here, it may not be preferable that the predetermined traveling mode be always performed on the basis of the same allowable zone B3. An example thereof is a case in which the oil temperature in a transaxle (power transmission part) is low just after the cold start or the like. When the oil temperature is low, a loss due to the rotational resistance or the like is greater than that when the oil temperature is an appropriate temperature. Accordingly, the oil temperature may be early raised to the appropriate temperature. In a hybrid vehicle, whether to perform a traveling mode may be determined depending on the oil temperature. For example, when the oil temperature is low, the performing of the EV traveling mode may not be allowed. In the vehicle 1 according to this embodiment, when the oil temperature is low, the EV traveling mode is inhibited and the HV traveling mode is performed.

When the EV traveling mode is inhibited, the HV traveling mode is selected even in an operating zone in which the EV traveling mode is originally more advantageous than the HV traveling mode in terms of the fuel efficiency or the like. Accordingly, the oil temperature may be early raised to the temperature at which the EV traveling mode can be selected. An example of the method of raising the oil temperature is a method of heating the oil with heat generated from the second rotary machine MG2 or heat due to agitation. That is, in the HV traveling mode, the increase in an amount of heat generated from the second rotary machine MG2 due to active operation of the second rotary machine MG2 is more advantageous in terms of the rise in the oil temperature than the selection of the predetermined traveling mode to stop the second rotary machine MG2.

The control unit 40 according to this embodiment changes the operating zone in which the predetermined traveling mode is allowed depending on the oil temperature, as will be described below with reference to FIGS. 9 and 10. Specifically, the control unit 40 further limits the operating zone in which the predetermined traveling mode is allowed when the oil temperature is low rather than when the oil temperature is high. Accordingly, as will be described below, the oil temperature can be earlier raised than when the operating zone in which the predetermined traveling mode is allowed is not changed. In FIG. 9, the horizontal axis represents the oil temperature in the transaxle and the vertical axis represents the drive force. The oil temperature in the transaxle is detected by the oil temperature sensor 5. The allowable zone A1 illustrated in FIG. 9 is a range of the drive force in which the predetermined traveling mode is allowed. The allowable zone A1 represents the correspondence between the oil temperature and the range of the drive force in which the predetermined traveling mode is allowed. The upper limit value of the allowable zone A1 or the range of the drive force of the allowable zone A1 varies depending on the oil temperature.

In a low temperature zone Rn1 in which the oil temperature is equal to or lower than a predetermined temperature T1, the predetermined traveling mode is inhibited. In other words, in the low temperature zone Rn1 equal to or lower than the predetermined temperature T1, the allowable zone A1 is not present. Accordingly, in the low temperature zone Rn1, new transition to the predetermined traveling mode is inhibited. In the low temperature zone Rn1, when the predetermined traveling mode is already performed, the predetermined traveling mode ends. In a middle temperature zone Rn2 in which the oil temperature is higher than the predetermined temperature T1 and equal to or lower than a second predetermined temperature T2, the allowable zone A1 is enlarged with the rise in the oil temperature. Specifically, with the rise of the oil temperature from the predetermined temperature T1 to the second predetermined temperature T2, the upper limit value of the allowable zone A1 increases. In a high temperature zone Rn3 in which the oil temperature is higher than the second predetermined temperature T2, the allowable zone A1 is uniform. That is, in the high temperature zone Rn3, the upper limit value of the allowable zone A1 is constant regardless of the oil temperature.

The vehicle control system 100 according to this embodiment inhibits the predetermined traveling mode when the oil temperature is lower than the predetermined temperature T1, as illustrated in FIG. 9. Since the predetermined traveling mode is inhibited, the HV traveling mode using the second rotary machine MG2 as the drive source is performed in the vehicle 1 according to this embodiment. Accordingly, the oil can be heated with the heat generated from the second rotary machine MG2 to early raise the oil temperature. As a result, it is possible to reduce the loss due to the viscosity of oil or to early start the EV traveling mode. In the vehicle control system 100 according to this embodiment, when the oil temperature is equal to or lower than the predetermined temperature T1, the predetermined traveling mode is inhibited and the vehicle 1 travels in the HV traveling mode. Accordingly, it is possible to achieve improvement in the fuel efficiency by causing the vehicle to rapidly reach the operation state in which the warm-up has been finished.

The HV-ECU 50 may maintain the engagement of the first clutch CL1 when the oil temperature is equal to or lower than the predetermined temperature T1. When the first clutch CL1 is engaged, the oil can be heated with the heat generated from the second rotary machine MG2 even in the case in which the second rotary machine MG2 is made to perform regeneration as well as the cases in which the second rotary machine MG2 is operated to cause the vehicle 1 to run forward or in reverse. Even when the second rotary machine MG2 is not made to perform powering and the regeneration, the second rotary machine MG2 rotates together. Since the second rotary machine MG2 rotates, the oil can be circulated to uniformize the oil temperature in the transaxle. Accordingly, for example, the remaining of the low-temperature oil in the vicinity of the second rotary machine MG2 is suppressed.

In this embodiment, as illustrated in FIG. 9, in the range of the oil temperature (the middle temperature zone Rn2) higher than the predetermined temperature T1, the operating zone (allowable zone A1) in which the predetermined traveling mode is allowed is enlarged with the rise in the oil temperature. Specifically, in the middle temperature zone Rn2 in the map illustrated in FIG. 9, the upper limit of the allowable zone A1 moves to a high load side with the rise in the oil temperature. In other words, when the oil temperature is low, the upper limit of the operating zone in which the predetermined traveling mode is allowed has a value closer to a low load than when the oil temperature is high, and thus the operating zone in which the predetermined traveling mode is allowed is limited. The range of the drive force of the allowable zone A1 is enlarged with the rise in the oil temperature. In other words, when the oil temperature is low, the range of the drive force of the operating zone in which the predetermined traveling mode is allowed is more narrowed than when the oil temperature is high, and thus the operating zone in which the predetermined traveling mode is allowed is limited.

With the rise in the oil temperature, the viscosity of oil decreases and thus the loss due to the viscosity decreases. In this embodiment, the degree to which the operating zone in which the predetermined traveling mode is allowed is limited decreases with the rise in the oil temperature. That is, when the oil temperature rises, the criterion for determining whether to allow the predetermined traveling mode is relaxed. Accordingly, it is possible to achieve both the decrease in loss due to performing of the predetermined traveling mode and the decrease in loss due to the rise in the oil temperature.

The map of the allowable zone A1 illustrated in FIG. 9 is determined for each vehicle speed. That is, in this embodiment, a three-dimensional map representing a zone in which the predetermined traveling mode is allowable is determined on the basis of three parameters of the vehicle speed, the temperature, and the drive force. A cross-section of the three-dimensional map at a vehicle speed is the map illustrated in FIG. 9 and a cross-section at a predetermined oil temperature is the map illustrated in FIG. 10.

The condition setting unit 50c sets the map (the map illustrated in FIG. 10) representing the relationship between the vehicle speed and the range of the drive force in which the predetermined traveling mode is allowable, that is, the map effective at a current oil temperature, on the basis of the current oil temperature. In other words, the condition setting unit 50c sets a condition of the operating zone in which the predetermined traveling mode can be performed at the current oil temperature. The condition setting unit 50c further limits the operating zone in which the predetermined traveling mode is allowed when the oil temperature is low rather than when the oil temperature is high. The condition setting unit 50c raises the degree to which the operating zone in which the predetermined traveling mode is allowed is limited as the oil temperature is lowered. When the oil temperature is equal to or lower than the predetermined temperature T1, the condition setting unit 50c most raises the degree to which the operating zone in which the predetermined traveling mode is allowed is limited and inhibits the predetermined traveling mode. The predetermined temperature T1 in this embodiment is a value constant regardless of the vehicle speed. The predetermined temperature T1 may vary depending on the vehicle speed. The second predetermined temperature T2 in this embodiment is a value constant regardless of the vehicle speed. The second predetermined temperature T2 in this embodiment is not constant regardless of the vehicle speed, but the second predetermined temperature T2 in this embodiment may vary depending on the vehicle speed.

In the map illustrated in FIG. 10, an allowable zone B3 and an allowable zone B1 are shown for comparison. The allowable zone B3 is an allowable zone in which the oil temperature is higher than the second predetermined temperature T2. The allowable zone B1 is an allowable zone in which the oil temperature is higher than the predetermined temperature T1 and equal to or lower than the second predetermined temperature T2. As illustrated in FIG. 10, the allowable area B3 in which the oil temperature is high (the high temperature zone Rn3 illustrated in FIG. 9) includes an operating zone with a lower vehicle speed or a higher load than the allowable zone B1 in which the oil temperature is relatively low (the middle temperature zone Rn2 illustrated in FIG. 9). The allowable zone B3 in which the oil temperature is high is an operating zone including the allowable zone B1 in which the oil temperature is relatively low and is an operating zone broader than the allowable zone B1 in which the oil temperature is relatively low.

The upper-limit drive force of the allowable zone B1 varies depending on the oil temperature. The upper limit of the allowable zone B1 moves to a low load side with the fall in the oil temperature and moves to a high load side with the rise in the oil temperature. That is, the allowable zone B1 is reduced to the low load side with the fall in the oil temperature and the allowable zone B1 is enlarged to the high load side with the rise in the oil temperature.

The operation of the vehicle control system 100 according to this embodiment will be described below with reference to FIG. 1. The control flow illustrated in FIG. 1 is performed while the vehicle 1 is traveling and is repeatedly performed, for example, with a predetermined cycle.

In step ST1, the HV_ECU 50 collects vehicle information. The HV_ECU 50 acquires the vehicle speed, the accelerator opening, the MG1 rotation speed, the MG2 rotation speed Nm2, the output shaft rotation speed Nout, the state of charge SOC of the battery 4, the oil temperature, and the like. The HV_ECU 50 calculates the shaft rotation speed Ns which is the rotation speed of the rotation shaft Sh on the basis of the gear ratio of the reduction gear 31 and the driven gear 21 and the acquired output shaft rotation speed Nout. When step ST1 is performed, the control flow goes to step ST2.

In step ST2, the HV_ECU 50 determines whether the oil temperature is equal to or less than a threshold value. The HV_ECU 50 determines whether the oil temperature acquired in step ST1 is equal to or lower than the predetermined temperature T1. The predetermined temperature T1 is determined, for example, on the basis of the relationship between the oil temperature and the viscosity of oil for the transaxle (TA). For example, the predetermined temperature T1 is an upper-limit temperature at which the viscosity of oil is equal to or greater than predetermined viscosity. The HV_ECU 50 determines that the determination result of step ST2 is positive when the oil temperature is equal to or lower than the predetermined temperature T1. The control flow goes to step ST3 when it is determined in step ST2 that the oil temperature is equal to or lower than the threshold value (Y in step ST2), and the control flow ends otherwise (N in step ST2).

In step ST3, the HV_ECU 50 determines whether the MG2 rest mode is performed. The HV_ECU 50 determines that the determination result of step ST3 is positive when the vehicle 1 travels in the predetermined traveling mode. The control flow goes to step ST4 when it is determined in step ST3 that the MG2 rest mode is performed (Y in step ST3), and the control flow goes to step ST5 otherwise (N in step ST3).

In step ST4, the HV_ECU 50 performs return to the THS mode. When the determination result of step ST2 is positive, the mode determining unit 50b of the HV_ECU 50 selects the HV traveling mode, that is, the HV traveling mode (THS mode) using the engine 2 and the second rotary machine MG2 as the drive source.

The HV_ECU 50 determines a command value of the engine torque and a command value of the MG2 torque on the basis of the request drive force for the vehicle 1 so as to perform the THS mode. The HV_ECU 50 outputs the determined command value of the MG2 torque to the MG_ECU 60 and outputs the determined command value of the engine torque to the engine ECU 70. The MG_ECU 60 controls the current supplied to the second rotary machine MG2 or the amount of electric power generated from the second rotary machine MG2 depending on the command value of the MG2 torque. The engine ECU 70 performs control of the throttle opening or the fuel injection of the engine 2, the ignition control, and the like depending on the command value of the engine torque.

When the request drive force for the vehicle 1 is small, the HV_ECU 50 may output power greater than the request drive force to the engine 2 and may cause the second rotary machine MG2 to perform the regeneration. For example, when the engine torque is greater than the request torque for the vehicle 1 at the time of operating the engine 2 at an operating point in an optimal fuel efficiency line, the surplus torque may be absorbed by the second rotary machine MG2. In other words, when the oil temperature is low, it is preferable that the second rotary machine MG2 be appropriately be made to rotate or to perform the regeneration depending on the request drive force to heat the oil while realizing the request drive force. When step ST4 is performed, the control flow goes to step ST5.

In step ST5, the mode determining unit 50b instructs to inhibit the MG2 rest mode. The mode determining unit 50b inhibits new transition to the predetermined traveling mode. The mode determining unit 50b, for example, sets a predetermined traveling mode inhibition flag to an ON state. The predetermined traveling mode inhibition flag is a flag indicating the inhibition of the predetermined traveling mode. The mode determining unit 50b has a predetermined traveling mode performance determining flow of determining whether to perform the predetermined traveling mode, in addition to the control flow. When the predetermined traveling mode inhibition flag is set to the ON state, the performing or start of the predetermined traveling mode is inhibited in the predetermined traveling mode performance determining flow. For example, the predetermined traveling mode is inhibited regardless of the vehicle speed or the request drive force.

On the other hand, when the predetermined traveling mode inhibition flag is set to an OFF state, the mode determining unit 50b determines that the predetermined traveling mode should be started or determines that the predetermined traveling mode should be ended, for example, on the basis of the maps illustrated in FIGS. 9 and 10. When it is instructed to inhibit the MG2 rest mode in step ST5, the control flow ends.

As described above, in the vehicle control system 100 according to this embodiment, it is possible to achieve the decrease in loss or the improvement in the fuel efficiency by early raising the oil temperature when the oil temperature is low.

A first modification example of the above-mentioned embodiment will be described below. FIG. 11 is a map of an allowable zone according to the first modification example of the embodiment. In the above-mentioned embodiment, when the oil temperature is in the middle temperature zone Rn2, the upper-limit drive force of the allowable zone B1 varies, but the allowable zone B1 may vary in the direction of the vehicle speed.

The allowable zone B2 illustrated in FIG. 11 is an allowable zone in which the oil temperature is higher than that of the allowable zone B1 illustrated in FIG. 9. The upper limit value of the allowable zone B2 is greater than the upper limit value of the allowable zone B1. The allowable zone B2 covers a lower vehicle speed side than the allowable zone B1. In other words, at the same value of the drive force, the lower-limit vehicle speed of the allowable zone B2 is lower than the lower-limit vehicle speed of the allowable zone B1. According to this modification example, the allowable zone in which the oil temperature is in the middle temperature zone Rn2 can be appropriately enlarged or reduced depending on the variation of the oil temperature.

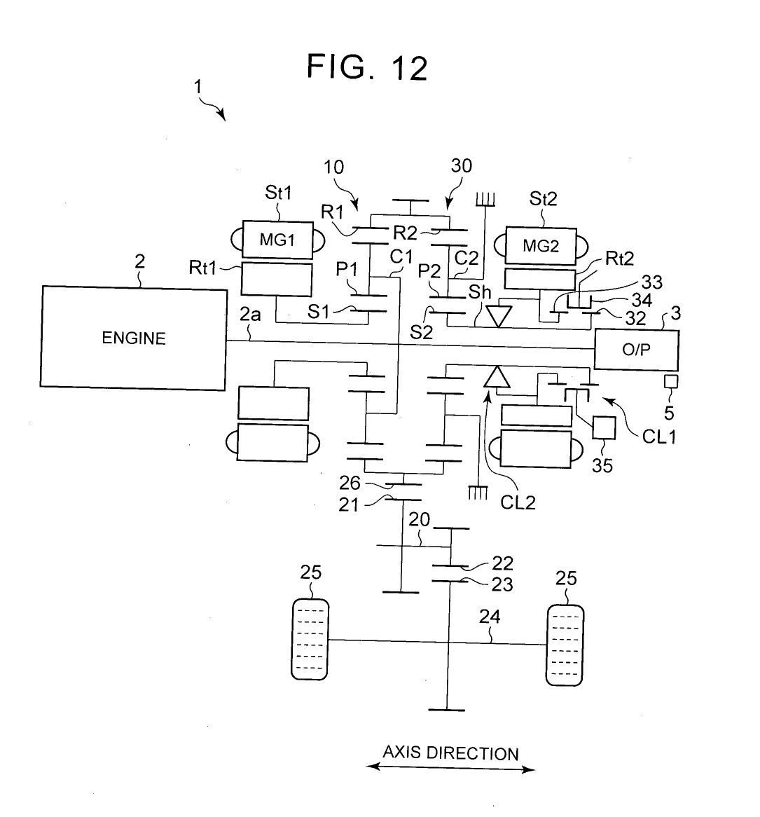

A second modification examples of the above-mentioned embodiment will be described below. FIG. 12 is a skeleton diagram illustrating a vehicle according to the second modification example of the embodiment. The transaxle according to the above-mentioned embodiment is of a multi-axis type in which the output shaft 2a of the engine 2 and the rotation shaft Sh of the second rotary machine MG2 are located in different axes. The transaxle according to the second modification example is different from that in the above-mentioned embodiment, in that the transaxle is of a single-axis type in which the engine 2 and the second rotary machine MG2 are disposed coaxial with each other.

As illustrated in FIG. 12, a first rotary machine MG1, a planetary gear mechanism 10, a second planetary gear mechanism 30, a second rotary machine MG2, and an oil pump 3 are arranged coaxial with the engine 2 sequentially from the side close to the engine 2. The planetary gear mechanism 10 is the same single-pinion planetary gear mechanism as the planetary gear mechanism 10 of the above-mentioned embodiment. The planetary gear mechanism 10 includes a sun gear S1, a pinion gear P1, a ring gear R1, and a carrier C1. The sun gear S1 is connected to the rotor Rt1 of the first rotary machine MG1. The carrier C1 is connected to the output shaft 2a of the engine 2.

The second planetary gear mechanism 30 is a single-pinion planetary gear mechanism and includes a second sun gear S2, a second pinion gear P2, a second ring gear R2, and a second carrier C2. The second sun gear S2 is connected to the rotation shaft Sh and rotates along with the rotation shaft Sh. The second carrier C2 is fixed to the vehicle body side and cannot rotate. The second ring gear R2 is connected to the ring gear R1 and rotates along with the ring gear R1. A common output gear 26 is disposed on the outer circumferences of the ring gear R1 and the second ring gear R2. The output gear 26 engages with a driven gear 21. The configurations of from the driven gear 21 to the driving wheels 25 may be the same as the configuration of the vehicle 1 according to the above-mentioned embodiment.

A first clutch CL1 and a second clutch CL2 are disposed between the rotation shaft Sh and the rotor Rt2 of the second rotary machine MG2. The second clutch CL2 is disposed in parallel to the first clutch CL1. The configurations of the first clutch CL1 and the second clutch CL2 may be the same as in the above-mentioned embodiment. In the vehicle 1 according to the second modification example, the positive rotation direction of the second rotary machine MG2 is opposite to the rotation direction of the output gear 26 when the vehicle 1 travels forward. The vehicle 1 according to the second modification example is equipped with the same vehicle control system 100 as the vehicle control system 100 (FIGS. 2, 4) according to the above-mentioned embodiment. In the vehicle 1 according to the second modification example, the vehicle control system 100 can perform the same control as in the above-mentioned embodiment and can achieve the same advantages.

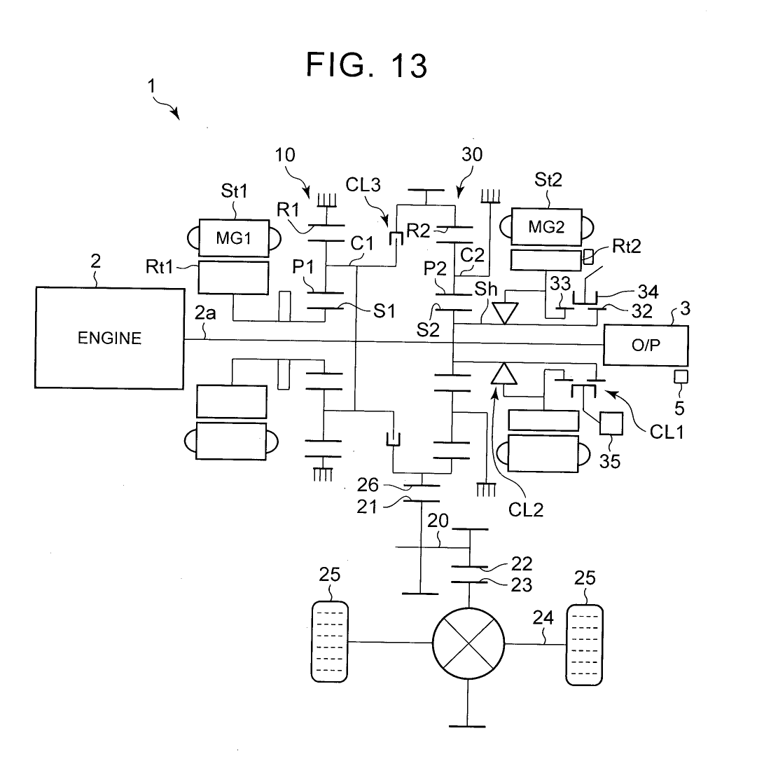

A third modification example of the above-mentioned embodiment will be described below. FIG. 13 is a skeleton diagram illustrating a vehicle according to the third modification example of the embodiment. The vehicle 1 according to the third modification example includes a third clutch CL3 disposed between the planetary gear mechanism 10 and the output gear 26. The third clutch CL3 is disposed between the carrier C1 and the output gear 26 and the second ring gear R2. The third clutch CL3 is, for example, a frictional engagement type multi-disk clutch and can be arbitrarily switched between an engaged state and a disengaged state. The sun gear S1 of the planetary gear mechanism 10 is connected to the rotor Rt1 of the first rotary machine MG1. The carrier C1 is connected to the output shaft 2a of the engine 2 and the third clutch CL3. The ring gear R1 is fixed to the vehicle body side and cannot rotate. The other configurations may be the same as the configurations of the vehicle 1 according to the second modification example of the embodiment.

In the vehicle 1, by disengaging the third clutch CL3, the cutoff state in which the side of the engine 2 and the first rotary machine MG1 and the side of the driving wheels 25 and the second rotary machine MG2 are disconnected. In the disconnected state, a series hybrid traveling mode can be carried out in which the vehicle 1 travels using the second rotary machine MG2 as the drive source by converting the power of the engine 2 into electric power through the use of the first rotary machine MG1 and supplying the electric power to the second rotary machine MG2. On the other hand, when the third clutch CL3 is engaged, the side of the engine 2 and the first rotary machine MG1 and the side of the driving wheels 25 and the second rotary machine MG2 are connected to each other. In the connected state, the parallel hybrid traveling mode can be carried out similarly to the above-mentioned embodiment or the second modification example.

The vehicle 1 according to the third modification example is equipped with the same vehicle control system 100 as the vehicle control system 100 (FIGS. 2, 4) according to the above-mentioned embodiment. In the vehicle 1 according to the third modification example, the vehicle control system 100 can perform the same control as in the above-mentioned embodiment and can achieve the same advantages. In the vehicle 1 according to the third modification example, the predetermined traveling mode is performed, for example, while the vehicle travels in the parallel hybrid traveling mode.

A fourth modification example of the above-mentioned embodiment will be described below. In the above-mentioned embodiment and the above-mentioned modification examples, the rotation of the second rotary machine MG2 is stopped in the predetermined traveling mode. The operating state of the second rotary machine MG2 in the predetermined traveling mode is not limited thereto. For example, in the predetermined traveling modem, the second rotary machine MG2 may rotates in the positive rotation direction at a rotation speed lower than the shaft rotation speed Ns. When the MG2 rotation speed Nm2 is lower than the shaft rotation speed Ns, the loss such as the dragging loss is reduced more than when the MG2 rotation speed Nm2 is equal to the shaft rotation speed Ns. When the second rotary machine MG2 is rotated in the predetermined traveling mode, the second rotary machine MG2 may be made to rotate or to perform the regeneration.

The configuration of the vehicle 1 is not limited to the configurations described in the above-mentioned embodiment or the above-mentioned modification examples. For example, the second rotary machine MG2 may be disposed at a position other than described above. In a configuration in which the engine 2, the first rotary machine MG1, and the driving wheels 25 are connected to different rotary elements of the planetary gear mechanism 10, it is preferable that the second rotary machine MG2 be connected to the power transmission path between the planetary gear mechanism 10 and the driving wheels 25 via the clutches CL1, CL2.

The vehicle 1 may be equipped with a single rotary machine (for example, the second rotary machine MG2) instead of being equipped with two rotary machines of the first rotary machine MG1 and the second rotary machine MG2. In this case, the first clutch CL1 and the second clutch CL2 can be disposed between the single rotary machine and the transmission path 11. The first clutch CL1 is not limited to the dog clutch, and may employ a friction type clutch. The first clutch CL1 may employ, for example, a wet or dry multi-disk clutch. The second clutch CL2 is not limited to the above-mentioned sprag type one-way clutch, and may employ another type one-way clutch. That is, the second clutch CL2 only has to have a function of transmitting a torque in one direction from one engagement element to the other engagement element and intercepting the transmission of a torque in the other direction.

The details described in the above-mentioned embodiment and the above-mentioned modification examples may be appropriately combined for practice.

1. A controller for a vehicle, the vehicle including an engine, a rotary machine, at least one driving wheel, a first clutch disposed between a power transmission path and the rotary machine, the power transmission path being defined between the engine and the driving wheel, the first clutch being switched to an engaged state or a disengaged state, a second clutch disposed in parallel with the first clutch, the second clutch being a one-way clutch, an oil temperature detector configured to detect a temperature of oil supplied to a power transmission part including the rotary machine, the controller comprising:
an electronic control unit configured to limit an operating zone in which a predetermined traveling mode is allowed when the oil temperature detected by the oil temperature detector is low compared to when the oil temperature is high, the predetermined traveling mode being a traveling mode in which the vehicle travels with a rotation of the rotary machine being stopped.

2. The controller according to claim 1, wherein
the electronic control unit is configured to inhibit the predetermined traveling mode when the oil temperature is equal to or lower than a predetermined temperature.

3. The controller according to claim 2, wherein
the electronic control unit is configured to cause the vehicle to travel using the rotary machine as a power source when the oil temperature is equal to or lower than the predetermined temperature.

4. The controller according to claim 2, wherein
the electronic control unit is configured to enlarge the operating zone in which the predetermined traveling mode is allowed as the oil temperature becomes higher in a temperature range in which the oil temperature is higher than the predetermined temperature.

5. The controller according to claim 3, wherein
the electronic control unit is configured to enlarge the operating zone in which the predetermined traveling mode is allowed as the oil temperature becomes higher in a temperature range in which the oil temperature is higher than the predetermined temperature.
